(19) United States
(12) Patent Application Publication
(10) Pub. No.: US 2015/0138094 A1
(43) Pub. Date: May 21, 2015

(54) ELECTRONIC APPARATUS, DOCKING APPARATUS, CONTROLLING METHOD THEREOF, AND COMPUTER-READABLE RECORDING MEDIUM

(71) Applicant: Samsung Electronics Co., Ltd., Suwon-si (KR)

(72) Inventor: Se-wan KIM, Yongin-si (KR)

(73) Assignee: Samsung Electronics Co., Ltd.

(21) Appl. No.: 14/325,488

(22) Filed: Jul. 8, 2014

(30) Foreign Application Priority Data
Nov. 20, 2013 (KR) 10-2013-0141264

(51) Int. Cl. G06F 1/16; G09G 5/12; G09G 5/00; G06F 3/041; G06F 3/02

(52) U.S. Cl. CPC G06F 1/1632; G06F 3/0416; G06F 3/0227; G09G 5/003; G09G 5/12; G06F 1/1662; G09G 2354/00
USPC 345/168; 345/173

(57) ABSTRACT

An electronic apparatus includes a communication interface configured to, when a docking apparatus including a keyboard and a display is connected, perform communication with the docking apparatus, a user interface configured to receive a user control command using a touch screen, and a controller configured to display image data on at least one of the display of the docking apparatus and the touch screen according to the input control command and whether the docking apparatus is mounted, and the electronic apparatus is disposed between the keyboard and the display.

### CROSS-REFERENCE TO RELATED APPLICATIONS

This application claims priority under 35 U.S.C. §119 from Korean Patent Application No. 10-2013-0141264, filed in the Korean Intellectual Property Office on Nov. 20, 2013, the disclosure of which is incorporated herein by reference in its entirety.

### BACKGROUND OF THE INVENTION

1. Field of the Invention

The present general inventive concept generally relates to an electronic apparatus, a docking apparatus, a controlling method, and a computer-readable recording medium, and more particularly, to an electronic apparatus capable of expanding an input and output function of the electronic apparatus, a docking apparatus, a controlling method, and a computer-readable recording medium.

2. Description of the Related Art

Recently, with the development of technology, functions of an electronic apparatus have been improved and have become increasingly sophisticated. In particular, a recent tablet PC has the capability of performing most of the jobs which are performed by a desktop PC.

However, a tablet PC has a relatively small display apparatus, and an input unit using a touch screen only. It may therefore be inconvenient to use a tablet PC for a business purpose. Accordingly, users who travel frequently in their jobs may end up carrying around both a notebook PC and a tablet PC.

However, carrying both a notebook PC and a high performance tablet PC may not be convenient. In addition, a conventional notebook PC does not use the functions of a high performance smart phone. Resources of the tablet PC may therefore go unused while a user is doing work using the notebook PC, which can result in a waste of resources.

### SUMMARY OF THE INVENTION

The present general inventive concept provides an electronic apparatus capable of expanding an input/output function of an electronic apparatus once it is connected to a docking apparatus, a docking apparatus that the electronic apparatus is being connected to, a controlling method to control the manner of data output in accordance with an operation state determined at least in part by the existence or non-existence of an electrical connection between an electronic apparatus and a docking apparatus, and a computer-readable recording medium.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an electronic apparatus including a communication interface configured to, when a docking apparatus including a keyboard and a display is connected, perform communication with the docking apparatus, a user interface configured to receive a user control command using a touch screen, and a controller configured to display image data on at least one of the display of the docking apparatus and the touch screen according to the received input control command and whether the docking apparatus is mounted, and the electronic apparatus is disposed between the keyboard and the display.

The controller, when the docking apparatus is mounted and a control command that requires displaying on the touch screen is input, may control to display image data on both the display of the docking apparatus and the touch screen, when the docking apparatus is mounted and a control command that does not require displaying on the touch screen is input, control to display image data only on the display of the docking apparatus, and when the docking apparatus is not mounted, control to display image data only on the touch screen.

The controller, when the docking apparatus is mounted and a control command that requires displaying on the touch screen is input, may control the user interface to display first image data on the touch screen, and may control the communication interface to display second image data on the display of the docking apparatus.

The controller may intercross and display image data which is displayed on the touch screen according to a predetermined control command.

The predetermined control command may be a predetermined touch pattern through the touch screen.

The controller, when the docking apparatus is mounted and a control command that requires displaying on the touch screen is input, may control the communication interface to display first area of image data on the display of the docking apparatus, and control the user interface to display second area of the image data on the touch screen.

The electronic apparatus may operate under a plurality of operating systems, the first image data may be image data according to an operation of a first operating system, and the second image data may be image data according to an operation of a second operating system which is different from the first operating system.

The controller, when the docking apparatus is mounted and a control command that does not require displaying on the touch screen is input, may control the communication interface to display first image data on the display of the docking apparatus, and control the user interface to operate the touch screen only as a touch pad.

The communication interface may receive a user control command which is input through the keyboard, and the controller may generate image data according to the received control command.

The foregoing and/or other features and utilities of the present general inventive concept may also be achieved by providing a docking apparatus to mount an electronic apparatus thereon and which may include a first body where a display to display image data received from the electronic apparatus is disposed and a second body where a keyboard for receiving a control command to control the electronic apparatus is disposed, and the electronic apparatus is mounted on an area of the second body between the keyboard and the display.

The foregoing and/or other features and utilities of the present general inventive concept may also be achieved by providing a controlling method of an electronic apparatus may include detecting whether the docking apparatus and the electronic apparatus are connected, when the electronic apparatus is mounted on the docking apparatus, receiving a user control command using a touch screen which is disposed between a keyboard of the docking apparatus and a display, and displaying image data on at least one of the display of the docking apparatus and the touch screen according to the input control command and whether the docking apparatus is mounted.

The displaying may include, when the docking apparatus is mounted and a control command that requires displaying on the touch screen is input, displaying image data on both the display of the docking apparatus and the touch screen, when the docking apparatus is mounted and a control command that does not require displaying on the touch screen is input, displaying image data only on the display of the docking apparatus, and when the docking apparatus is not mounted, displaying image data only on the touch screen.

The displaying may include, when the docking apparatus is mounted and a control command that requires displaying on the touch screen is input, displaying first image data on the touch screen, and displaying second image data on the display of the docking apparatus.

The displaying may include intercrossing and displaying image data which is displayed on the touch screen according to a predetermined control command.

The predetermined control command may be a predetermined touch pattern through the touch screen.

The displaying may include, when the docking apparatus is mounted and a control command that requires displaying on the touch screen is input, displaying first area of image data on the display of the docking apparatus, and displaying second area of the image data on the touch screen.

The electronic apparatus may operate under a plurality of operating systems, the first image data may be image data according to an operation of a first operating system, and the second image data may be image data according to an operation of a second operating system which is different from the first operating system.

The displaying may include, when the docking apparatus is mounted and a control command that does not require displaying on the touch screen is input, displaying first image data on the display of the docking apparatus while the touch screen operates only as a touch pad.

The receiving a user control command may include receiving a user control command which is input through a keyboard of the docking apparatus.

The foregoing and/or other features and utilities of the present general inventive concept may also be achieved by providing a computer readable recording medium including a program to execute a controlling method of an electronic apparatus according to an exemplary embodiment in which the controlling method includes detecting whether the docking apparatus is connected, when the electronic apparatus is mounted on the docking apparatus, receiving a user control command using a touch screen which is disposed between a keyboard of the docking apparatus and a display, and displaying image data on at least one of a display of the docking apparatus and the touch screen according to the input control command and whether the docking apparatus is mounted.

The foregoing and/or other features and utilities of the present general inventive concept may also be achieved by providing an electronic apparatus including a communication interface to communicate with a docking apparatus when electronically coupled thereto, a user interface to receive an input control command, and a controller to display image data on at least one of the electronic apparatus and the docking apparatus according to the received input control command and with regard to the electronic coupling.

The controller may display image data on both the electronic apparatus and the docking apparatus when the received input control command requires a displaying on the electronic apparatus, and may otherwise display image data only on the docking apparatus.

The controller may display image data only on the electronic apparatus when the communication interface is not electronically coupled to the docking apparatus.

The user interface may include a touch screen.

The electronic apparatus may further include a dock connector to connect with the docking apparatus such that the electronic apparatus is disposed between a keyboard and a display of the docking apparatus when connected.

The dock connector may mount the electronic apparatus on the docking apparatus.

The image data displayed on the docking apparatus may be displayed on a display screen of the docking apparatus.

The foregoing and/or other features and utilities of the present general inventive concept may also be achieved by providing a method of controlling an electronic apparatus that may include detecting whether the electronic apparatus is electronically coupled with a docking apparatus, receiving a user control command, determining an operation state of the electronic apparatus based on the detection and the received user control command, and displaying image data from the electronic apparatus in a manner dictated by the determined operation state.

The determining an operation state may include determining the operation state as a tablet state if no communicative coupling is detected. The tablet state may include displaying image data only on the touch screen of the electronic apparatus.

The determining an operation state may also include determining the operation state as a notebook state if a communicative coupling is detected and the received user control command does not require a displaying on a touch screen of the electronic apparatus. The notebook state may include displaying image data only on a display of the docking apparatus.

The determining an operation state may also include determining the operation state as a dual display state If a communicative coupling is detected and the received user control command requires displaying on the touch screen of the electronic apparatus. The dual display state may include displaying image data on both the touch screen of the electronic apparatus and the display of the docking apparatus.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a view illustrating an electronic apparatus and a docking apparatus separated from each other;

FIG. 2 is a view illustrating an electronic apparatus mounted on a docking apparatus;

FIG. 3 is a view illustrating a case where a docking apparatus is folded;

FIG. 4 is a view provided to illustrate a specific configuration of the electronic apparatus of FIG. 1;

FIG. 5 is a view provided to illustrate an operation when an electronic apparatus is connected to a docking apparatus according to an exemplary embodiment of the present general inventive concept;

FIG. 6 is a view illustrating a touch screen in the first dual display state and an example of a user interface window which can be displayed on a display;

FIG. 7 is a view illustrating an example of a user interface window which can be displayed on a touch screen of the electronic apparatus and the display of the docking apparatus in the second dual display state;

FIG. 8 is a view illustrating an example of a user interface window which can be displayed in the touch screen of the electronic apparatus and the display of the docking apparatus in a notebook PC state; and

FIG. 9 is a flowchart provided to illustrate a controlling method according to an exemplary embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

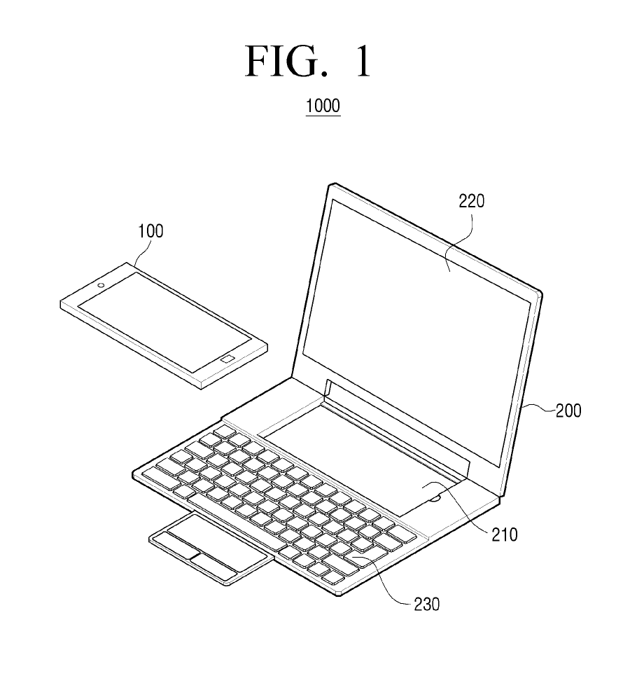

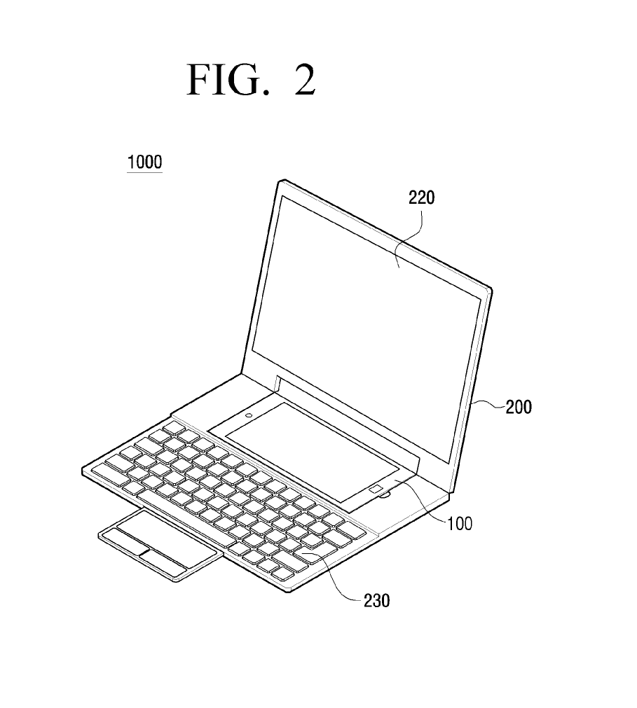

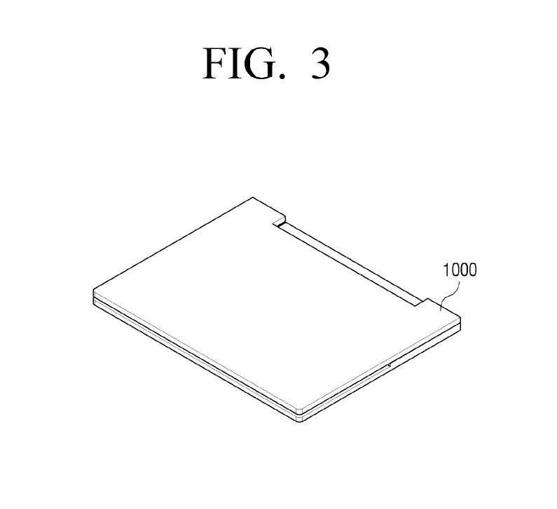

FIGS. 1 through 3 are views provided to illustrate a docking system 1000 according to an exemplary embodiment of the present general inventive concept. Specifically, FIG. 1 is a view illustrating a case where an electronic apparatus 100 and a docking apparatus 200 are separated from each other, FIG. 2 is a view illustrating a case where an electronic apparatus 100 is mounted on a docking apparatus 200, and FIG. 3 is a view illustrating a case where a docking apparatus 200 is folded.

Referring to FIGS. 1 through 3, a docking system 1000 includes an electronic apparatus 100, a docking apparatus 200, and a dock connector 210 disposed on the docking apparatus 200.

The electronic apparatus 100 receives a control command from a user, and performs a job according to the received control command. The electronic apparatus 100 may be connected to the docking apparatus 200 physically/electrically. The electronic apparatus 100 may be tablet PC, mobile phone, smart phone, PMP, MP3 player, etc.

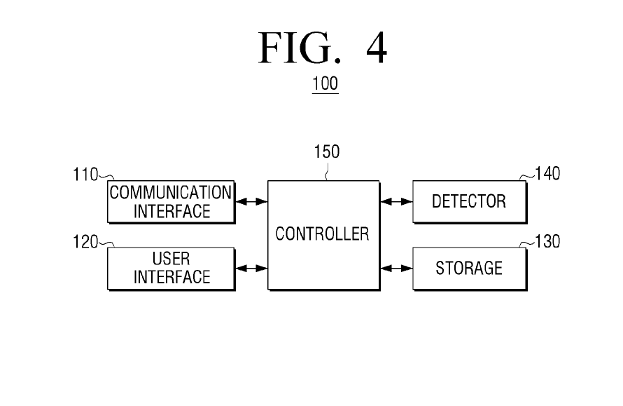

Specifically, the electronic apparatus 100 operates in a tablet state (or performs tablet functions) when it is not connected to the docking apparatus 200. Herein, the tablet state is a state (or function) where image data is displayed using only a touch screen. In addition, the electronic apparatus 100 may operate in a dual display state (or dual display function) or a notebook state (or notebook function) according to a user's controlling method when it is connected to the docking apparatus 200. Herein, the dual display state is a state (or function) where image data is displayed using both a display of the docking apparatus 200 and a touch screen of the electronic apparatus 100, and the notebook state is a state (or function) where an image is displayed using only a display of the docking apparatus 200. The specific operation and configuration of the display apparatus 100 will be described later with reference to FIG. 4.

The docking apparatus 200 is an apparatus which expands the functions of the electronic apparatus 100. The docking apparatus 200 does not operate by itself, and may operate only when it is mounted on the electronic apparatus 100. Specifically, the docking apparatus 200 includes a keyboard 230, a display 220, and the dock connector 210 disposed between the keyboard 230 and the display 220 and expands a user interface function of the electronic apparatus 100. In addition, the docking apparatus 200 may provide power to the electronic apparatus 100.

Further, the docking apparatus 200 may expand the communication function of the electronic apparatus 100. Specifically, the docking apparatus 200 may be connected to an external Internet network via cable LAN, and may relay cable LAN with respect to the electronic apparatus 100.

The docking apparatus 200 consists of a first body (or case) and a second body. The first body may be an upper body where the display 220 for displaying image data may be disposed, and the second body may be a lower body where the keyboard 230 to receive a control command may be disposed. The first body and the second body may be connected to each other through a hinge and thus, are folded as illustrated in FIG. 3 to have an appropriate size for mobility.

Meanwhile, referring to FIGS. 1 and 2, the electronic apparatus 100 may be mounted on the second body on the dock connector 210, which may be disposed between the display 220 and the keyboard 230. Accordingly, a touch screen of the electronic apparatus 100 is disposed to be adjacent to the display 220. Thus, if the electronic apparatus 100 operates in a dual display state, a user may check both the screen of the display 220 and the screen of the touch screen simultaneously with ease.

As such, the docking system 1000 according to an exemplary embodiment of the present general inventive concept, when the electronic apparatus 100 is mounted on the docking apparatus 200, may provide various user interface environments as a display function is expanded. In addition, the docking apparatus 200, unlike a conventional notebook PC, may not have a control element (for example, CPU, RAM, and HDD) and thus, may be realized in a lighter and slimmer manner. Further, the docking apparatus 200 provides a display 220 with a large screen, so it can be realized in a small screen to improve portability of the electronic apparatus 100.

Meanwhile, in FIGS. 1 and 2, a touch pad is further disposed in front of the keyboard 230, but an electronic apparatus 100 according to an exemplary embodiment of the present general inventive concept may function as a touch panel and thus, a touch pad may not be added in an exemplary embodiment of the present general inventive concept. In addition, a touch pad may be configured to be protruded in a sliding manner selectively only when the electronic apparatus 100 operates in a dual display state.

Further, in the above description with respect to FIG. 2, the electronic apparatus 100 and the docking apparatus 200 are connected electrically, but the electronic apparatus 100 may be connected to a predetermined home area of the docking apparatus 200 by a magnetic tool without any electric connection, and may be configured to transmit/receive image data through a wireless method.

FIG. 4 is a view provided to illustrate a specific configuration of an electronic apparatus 100 of FIG. 1.

Referring to FIG. 4, the electronic apparatus 100 according to an exemplary embodiment may consist of a communication interface 110, a user interface 120, a storage 130, a detector 140, and a controller 150. Herein, the electronic apparatus 100 may be tablet PC, mobile phone, smart phone, PMP, MP3 player, etc. which are connectable to the docking apparatus 200.

The electronic apparatus 100 has a plurality of operation states. Herein, the plurality of operation states includes a first operation state (that is, a tablet state) where an image is displayed only on a touch screen of the electronic apparatus 100, a second operation state (that is, a notebook state) where the electronic apparatus 100 is connected to the docking apparatus 200 and an image is displayed only on the display 220 of the docking apparatus 200, and a third operation state (that is, a dual display state) where the electronic apparatus 100 is connected to the docking apparatus 200 and an image is displayed on both the touch screen and the display 220 of the docking apparatus 200 simultaneously.

The first operation state is a state where the electronic apparatus 100 is not connected to the docking apparatus 200 and thus, an image can be displayed only on one touch screen of the electronic apparatus 100. However, the electronic apparatus 100 according to an exemplary embodiment of the present general inventive concept may operate using a plurality of operating systems and thus, an image screen according to a plurality of operating systems may be displayed under the control of a user. For example, while a first image is being displayed by a first operating system, a second image by a second operating system may be displayed instead of the first image under the control of a user. Herein, the first operating system may be Android, and the second operating system may be Windows. Meanwhile, in the above exemplary embodiment of the present general inventive concept, although only Android and Windows operating systems are mentioned, other operating systems may also be applied.

The second operation state is a state where the electronic apparatus 100 is connected to the docking apparatus 200 and thus, an image may be displayed on the display 220 of the docking apparatus 200. However, as the touch screen does not display any image, the touch screen may be served as a touch pad (or a track pad) of a conventional notebook PC.

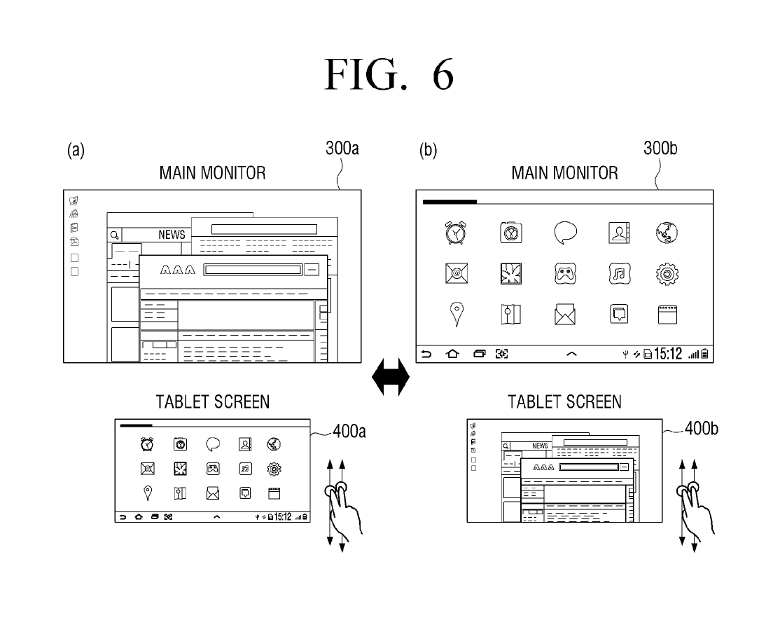

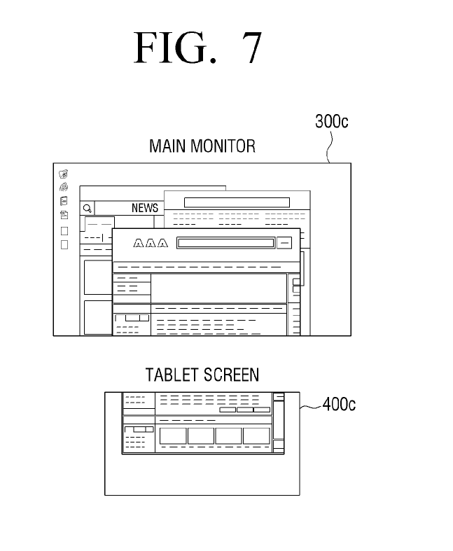

The third operation state is a state where the electronic apparatus 100 is connected to the docking apparatus 200 and thus, an image may be displayed on the display 220 of the docking apparatus 200, and an image may also be displayed on the touch screen. That is, an image may be displayed on two display apparatus which are provided physically. In this case, the third operation state may be classified into a first dual display state and a second dual display state according to the dependency of an image which is displayed on the display 220 and the touch screen, which will be described later with reference to FIGS. 6 and 7.

The communication interface 110 is formed to connect the electronic apparatus 100 to an external apparatus (not illustrated) via not only Local Area Network (LAN) and Internet network but also a wireless communication (wireless communication such as GSM, UMTS, LTE, WiBRO, etc.) method.

In addition, the communication interface 110 may communicate with the docking apparatus 200. Specifically, when the electronic apparatus 100 is connected to the docking apparatus 200, the communication interface 110 may receive a user control command from the docking apparatus 200, and may transmit an image (or a video) to be displayed on the docking apparatus 200. Further, the communication interface 110 may connect to an external apparatus or Internet network through the docking apparatus 200.

The user interface 120 may display various information provided by the electronic apparatus 100. The user interface 120 may be realized as an apparatus which is capable of performing input and output operations simultaneously, just like a touch screen. Meanwhile, the user interface 120 may further include a specific button, etc.

In addition, the user interface 120 may receive a user control command. Specifically, the user interface 120 may receive various touch gestures through a touch screen. Meanwhile, when the electronic apparatus 100 operates in a notebook state, the user interface 120 may control to receive a touch gesture even though an image is not displayed on the touch screen. In this case, the user interface 120 may display that the touch screen is operated as a touch pad. For example, the user interface 120 may display a screen corresponding to the shape of touch pad. Herein, the received control command may be used to determine the operation state of the above-described electronic apparatus 100. For example, a control command to control the touch screen to function as a touch pad while a docking apparatus 200 is mounted may be received, and a control command to display an image on the touch screen as well may be received. In the above exemplary embodiment of the present general inventive concept, a control command for directly determining an operation state is input, but a control command of a specific application or a specific macro command may be used to determine an operation state.

In addition, the user interface 120 may cause various information provided by the electronic apparatus 100 to be displayed on the docking apparatus 200 through the communication interface 110. Specifically, when the electronic apparatus 100 is connected to the docking apparatus 200, the user interface 120 may control the communication interface 110 to display a user interface window to be displayed on the electronic apparatus 100 on the docking apparatus 200. The various display types of the user interface 120 and the docking apparatus 200 will be described later with reference to FIGS. 6 through 8.

Further, when the electronic apparatus 100 is connected to the docking apparatus 200, the user interface 120 may display that the docking apparatus 200 is connected. When the docking apparatus 200 is removed, the user interface 120 may display that the docking apparatus 200 is removed.

The storage 130 may store a program to drive the electronic apparatus 100. Specifically, the storage 130 may store a program which is a group of various commands which are necessary to drive the electronic apparatus 100. Herein, the program includes not only an application program to provide a specific service but also an operating program to drive an application program. Herein, the operating program may include the first operating system and the second operating system. Specifically, the first operating system may be an Android operating system which is driven in a smart phone, etc., and the second operating system may be a Windows operating system which is driven in a notebook PC, a desktop PC, etc.

The storage 130 may be realized as a storage medium of the electronic apparatus 100 or an external storage medium, such as a Removable Disk including a USB memory, a web server via network, etc.

The detector 140 may detect whether the docking apparatus 200 is mounted. Specifically, the electronic apparatus 100 may include a connector that can be connected to the docking apparatus 200 physically/electrically, and when the docking apparatus 200 is electrically connected to the connector, the detector 140 may detect that the electronic apparatus 100 is mounted on the docking apparatus 200. Meanwhile, if an adapter power is input through the docking apparatus 200, the detector 140 may detect whether the docking apparatus 200 is mounted based on whether the adapter power is input.

The controller 150 controls each element of the electronic apparatus 100. Specifically, the controller 150 determines an operation state according to whether the docking apparatus 200 is mounted and a user control command. More specifically, if the docking apparatus 200 is not mounted on the electronic apparatus 100, the controller 150 determines the operation state of the electronic apparatus 100 to be a tablet state, if the electronic apparatus 100 is mounted on the docking apparatus 200, and a user wishes to display only one image, the controller 150 may determine the operation state of the electronic apparatus 100 to be a notebook PC state, and if a user wishes to display only two images, the controller 150 may determine the operation state of the electronic apparatus 100 to be a dual display state.

Meanwhile, in the exemplary embodiment, a notebook PC state and a dual display state are determined according to a user control command (for example, if the docking apparatus 200 is mounted, a screen to receive a selection of the state is displayed on the touch screen or the display 220 and receives a selection of a passage display method), but an operation may be performed according to a predetermined selection, and may be determined based on the number of operating systems of the electronic apparatus 100. For example, if the docking apparatus 200 is connected while an operation is performed by one operating system, the controller 150 may determine the operation state of the electronic apparatus 100 to be a notebook PC state, and if the docking apparatus 200 is connected while an operation is performed by a plurality of operating systems, the controller 150 may determine the operation state of the electronic apparatus 100 to be a dual display state.

The controller 150 may control to display image data on at least one of the display 220 of the docking apparatus 200 and a touch screen according to the determined operation state. Specifically, if the operation state of the electronic apparatus 100 is a tablet state, the controller 150 may control the user interface 120 to display one image on the touch screen, and if the operation state of the electronic apparatus 100 is a notebook PC state, the controller 150 may control the communication interface 110 to display one image on the display 220. In this case, the controller 150 may control the touch screen to operate as a touch pad which detects only a user touch without displaying an image.

In addition, the controller 150 may determine an operating system to be driven. Specifically, the controller 150 may determine an operating system based on whether the docking apparatus 200 is connected. For example, if it is a tablet state where the docking apparatus 200 is not connected, the controller 150 may control to operate under the first operating system (Android). Meanwhile, if the docking apparatus 200 is connected, the controller 150 may control to operate under the second operating system (Windows). Meanwhile, if the docking apparatus 200 is connected while an operation is performed under the first operating system, the controller 150 may control to operate a dual O/S. That is, the controller 150 may control to display a screen according to the first operating system on either one of the touch screen or the display 220, and display a screen according to the second operating system on the other.

If the operating state of the electronic apparatus 100 is a dual display state, the controller 150 may control the communication interface 110 and the user interface 120 to display an image on the display 220 and the touch screen, respectively.

As such, the electronic apparatus 100 according to an exemplary embodiment may control the display state of a plurality of display apparatuses adaptively based on whether the docking apparatus 200 is mounted and thus, may improve user convenience. In addition, the electronic apparatus 100 according to an exemplary embodiment may operate under a plurality of operating systems and thus, may perform various operations according to the connection state of the docking apparatus 200.

Meanwhile, in the above description regarding FIG. 1, the operation state of the electronic apparatus 100 is determined, and each element is controlled according to the determined operation state, but when specific conditions are satisfied, a corresponding element may be controlled directly without the process of determining the operation state. For example, if a docking apparatus 200 is connected, and a user selects displaying on two display apparatus, an image may be displayed on both the display 220 of the docking apparatus 200 and the touch screen without the process of determining the operation state.

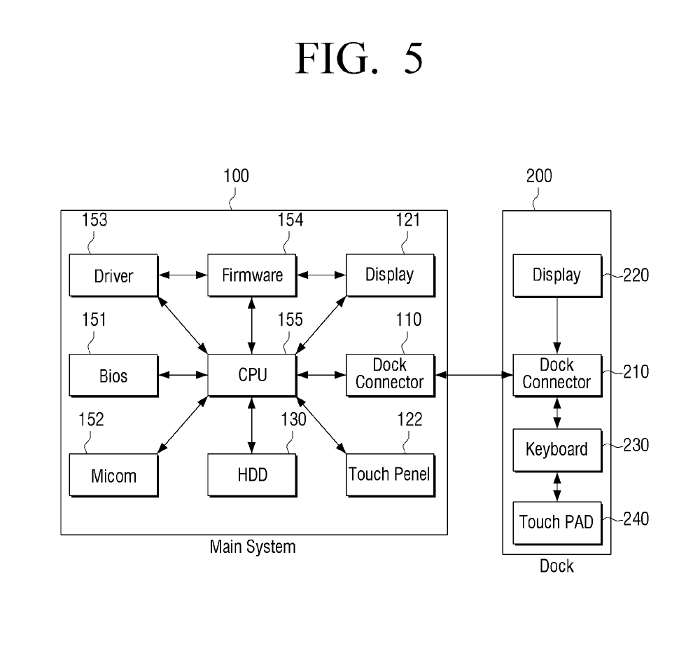

FIG. 5 is a view provided to illustrate an operation when an electronic apparatus 100 is connected to a docking apparatus 200 according to an exemplary embodiment of the present general inventive concept.

Referring to FIG. 5, the docking system 1000 according to an exemplary embodiment may consist of the electronic apparatus 100 and the docking apparatus 200.

The electronic apparatus 100 may be connected to the docking apparatus 200. Specifically, the electronic apparatus 100 may include the communication interface 110, the user interface 120, a storage 130, a bios 151, a micom 152, a driver 153, firmware 154, and a CPU 155.

The communication interface 110 (specifically, a dock connector) is formed to connect the electronic apparatus 100 to the docking apparatus 200, and may be connected through a serial interface method such as USB and HDMI. Meanwhile, in an exemplary embodiment of the present general inventive concept, the electronic apparatus 100 and the docking apparatus 200 may be connected via cable, but the communication interface 110 may connect the electronic apparatus 100 with the docking apparatus 200 physically and transmit/receive various signals through a wireless method.

The communication interface 110 may receive a user control command from the docking apparatus 200, and transmit an image to be displayed on the docking apparatus 200. In addition, the communication interface 110 may perform communication with various apparatuses connected to the docking apparatus 200.

The user interface 120 may display various information provided by the electronic apparatus 100. In addition, the user interface 120 may generate image data to be displayed on the display 220 of the docking apparatus 200.

The storage 130 performs the same functions as the storage 130 of FIG. 4, so further description will not be provided.

The bios 151 is a program which may take control of controlling a computer initially when power of the computer is turned on and may process very basic functions. Specifically, at the time of booting the electronic apparatus 100, the bios 151 may proceed with a series of booting process by performing initialization of each element of the electronic apparatus 100. In this case, the bios 151 may proceed with a selective booting process according to whether a docking apparatus 200 is connected. For example, if a docking apparatus 200 is not connected, the bios 151 may proceed with booting under the first operating system (Android), and if a docking apparatus is connected, the bios 151 may proceed with booting under the second operating system (Windows).

The micom 152 may control various chipsets of the electronic apparatus 100. Specifically, the control operations with respect to the performance of the CPU may be performed by the micom 152 as described above.

The driver 153 is an operation program with respect to various chipsets of the electronic apparatus 100.

The firmware 154 is a group of micro programs to control hardware and may be stored in ROM.

The CPU 155 is an apparatus which decodes a command, and performs arithmetic logic operation or data processing. Specifically, the CPU 155 generates image data. Meanwhile, if the electronic apparatus 100 operates under a plurality of operating systems, image data for each operating system may be generated. Meanwhile, in an exemplary embodiment of the present general inventive concept, the CPU may generate image data, but the electronic apparatus 100 may include a graphic processor which exclusively generates image data.

The docking apparatus 200 may be connected to the electronic apparatus 100. Specifically, the docking apparatus 200 may include a dock connector 210, a display 220, a keyboard 230, and a touch pad 240.

The dock connector 210 (or a communication interface) may be formed to connect the docking apparatus 200 with the electronic apparatus 100, and may be connected through a method such as USB, HDMI, serial interface, etc. Specifically, the dock connector 210 may transmit a user control command input from the keyboard 230 which will be described later or the touch pad 240 to the electronic apparatus 100. In addition, the dock connector 210 may receive an image from the electronic apparatus 100, and transmit the received image to the display 220.

The display 220 displays an input image. Specifically, the display 220 may display an image input from the electronic apparatus 100 through the dock connector 210.

The keyboard 230 and the touch pad 240 may include a plurality of function keys through which a user may set or select various functions provided by the electronic apparatus 100. A user command input through the keyboard 230 and the touch pad 240 may be transmitted to the electronic apparatus 100 through the dock connector 210. Meanwhile, in an exemplary embodiment of the present general inventive concept, the touch pad 240 may be included, but as the electronic apparatus 100 may perform the function of a touch pad, the touch pad 240 may not be provided. When the electronic apparatus 100 performs the function of a touch pad, the function of the touch pad 240 may be inactivated.

FIGS. 6 through 8 are views illustrating a user interface of FIG. 5 and various examples of a user interface window which is displayed by a display, respectively.

Specifically, FIG. 6 is a view illustrating a touch screen in the first dual display state and an example of a user interface window which can be displayed on a display.

Referring to FIG. 6, the touch screen may display first image data 400A according to the operation of the first operating system (Android), and the display 220 may display second image data 300A according to the operation of the second operating system (Windows).

In this case, if a user inputs a predetermined touch pattern (e.g., scrolling two touch areas in a vertical direction in the drawing) on the touch screen, image data displayed on the touch screen and the display 220, respectively, may be intercrossed and displayed. Accordingly, the touch screen may display the second image data 400B according to the operation of the second operating system, and the display 220 may display the first image data 300B according to the operation of the first operating system.

Meanwhile, in an exemplary embodiment of the present general inventive concept, the touch screen and the display 220 may display an image according to a different operating system, but they may display an image according to the same operating system as illustrated in FIG. 7.

FIG. 7 is a view illustrating an example of a user interface window which can be displayed on the touch screen and the display 220 in the second dual display state.

Referring to FIG. 7, the touch screen may display the first area 400C of image data according to the operation of the second operating system (Window), and the display 220 may display the second area 300C of image data (the area excluding the first area) according to the operation of the second operating system.

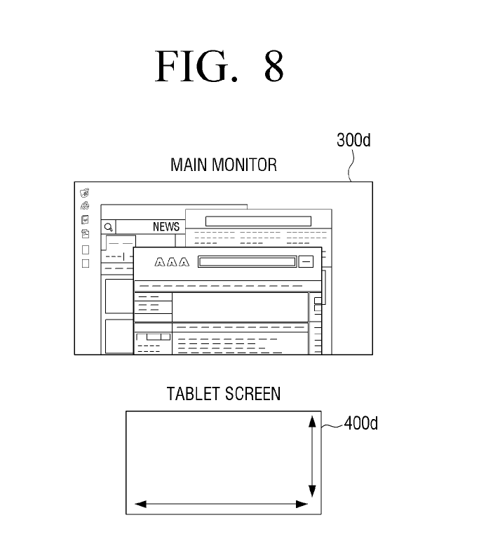

FIG. 8 is a view illustrating an example of a user interface window which can be displayed in the touch screen and the display in a notebook PC state.

Referring to FIG. 8, the display 220 of the docking apparatus 200 displays an image screen 300D, but the touch screen 400D does not display any image. That is, the touch screen performs the function of only detecting a user touch just like a touch pad without displaying an image.

Meanwhile, if the electronic apparatus 100 operates under a plurality of operating systems, the electronic apparatus 100 may operate in various forms in the case of FIG. 8. For example if the electronic apparatus 100 is connected to the docking apparatus 200 while the electronic apparatus 100 operates under the first operating system (Android), the display 220 of the docking apparatus 200 may display the first image data which is generated according to the operation of the first operating system. In an exemplary embodiment, the operating system may be converted and the second operating system may further operate and thus, the second image data which is generated according to the second operating system may be displayed.

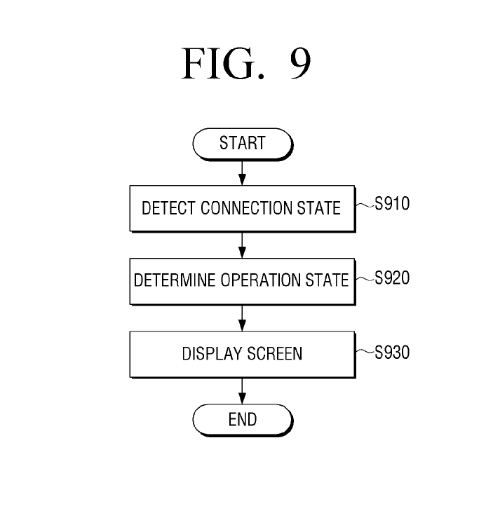

FIG. 9 is a flowchart provided to illustrate a controlling method according to an exemplary embodiment of the present general inventive concept.

Referring to FIG. 9, whether a docking apparatus 200 is connected is detected (S910). Specifically, whether a docking apparatus 200 is connected may be detected based on whether the docking apparatus 200 is electrically connected to a connector.

The operation state of the electronic apparatus 100 may be determined (S920). Specifically, the operation state may be determined based on whether the docking apparatus 200 is mounted and a user control command. More specifically, if the docking apparatus 200 is not mounted on the electronic apparatus 100, the operation state of the electronic apparatus 100 is determined to be a tablet state, if the electronic apparatus 100 is mounted on the docking apparatus 200 and a user wishes to display only one image, the operation state of the electronic apparatus 100 may be determined to be a notebook PC state, and if a user wishes to display only two images, the operation state of the electronic apparatus 100 may be determined to be a dual display state.

Subsequently, based on the determined operation state, image data may be displayed on at least one of the display 220 of the docking apparatus 200 and the touch screen (S930). Specifically, if a docking apparatus 200 is mounted and a control command which requires displaying on the touch screen is input, image data may be displayed on both the display 220 of the docking apparatus 200 and the touch screen. However, if a docking apparatus 200 is mounted and then a control command which does not require displaying on the touch screen is input, image data may be displayed only on the display 220 of the docking apparatus 200. Meanwhile, if a docking apparatus 200 is not mounted, image data may be displayed only on the touch screen.

The controlling method according to an exemplary embodiment of the present general inventive concept may control the display state of a plurality of display apparatuses adaptively according to whether the docking apparatus 200 is mounted and thus, may improve user convenience. In addition, the electronic apparatus 100 according to an exemplary embodiment of the present general inventive concept may operate under a plurality of operating systems and thus, may perform various operations according to the connection state of the docking apparatus 200. The controlling method of FIG. 9 may be performed in an electronic apparatus 100 having the configuration of FIG. 1, and may also be performed in an apparatus having other configurations.

In addition, the above-described controlling method may be realized as a program (or application) including an algorithm which is executable in a computer, and the program may be stored in a non-transitory computer readable medium and provided therein.

The non-transitory recordable medium refers to a medium which may store data semi-permanently rather than storing data for a short time such as a register, a cache, and a memory and may be readable by an apparatus.

The foregoing embodiments and advantages are merely exemplary and are not to be construed as limiting the present general inventive concept. The present teaching can be readily applied to other types of apparatuses. Also, the description of the exemplary embodiments of the present general inventive concept is intended to be illustrative, and not to limit the scope of the claims, and many alternatives, modifications, and variations will be apparent to those skilled in the art.

The present general inventive concept, as described above, can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An electronic apparatus, comprising:
a communication interface configured to, when a docking apparatus including a keyboard and a display is connected, perform communication with the docking apparatus;
a user interface configured to receive a user control command using a touch screen; and
a controller configured to display image data on at least one of the display of the docking apparatus and the touch screen according to the input control command and whether the docking apparatus is mounted,
wherein the electronic apparatus is disposed between the keyboard and the display.

2. The apparatus as claimed in claim 1, wherein the controller, when the docking apparatus is mounted and a control command that requires displaying on the touch screen is input, controls to display image data on both the display of the docking apparatus and the touch screen,
when the docking apparatus is mounted and a control command that does not require displaying on the touch screen is input, controls to display image data only on the display of the docking apparatus, and
when the docking apparatus is not mounted, controls to display image data only on the touch screen.

3. The apparatus as claimed in claim 2, wherein the controller, when the docking apparatus is mounted and a control command that requires displaying on the touch screen is input, controls the user interface to display first image data on the touch screen, and controls the communication interface to display second image data on the display of the docking apparatus.

4. The apparatus as claimed in claim 3, wherein the controller intercrosses and displays image data which is displayed on the touch screen according to a predetermined control command.

5. The apparatus as claimed in claim 4, wherein the predetermined control command is a predetermined touch pattern through the touch screen.

6. The apparatus as claimed in claim 2, wherein the controller, when the docking apparatus is mounted and a control command that requires displaying on the touch screen is input, controls the communication interface to display first area of image data on the display of the docking apparatus, and controls the user interface to display second area of the image data on the touch screen.

7. The apparatus as claimed in claim 3, wherein the electronic apparatus operates under a plurality of operating systems, the first image data is image data according to an operation of a first operating system, and the second image data is image data according to an operation of a second operating system which is different from the first operating system.

8. The apparatus as claimed in claim 2, wherein the controller, when the docking apparatus is mounted and a control command that does not require displaying on the touch screen is input, controls the communication interface to display first image data on the display of the docking apparatus, and controls the user interface to operate the touch screen only as a touch pad.

9. The apparatus as claimed in claim 1, wherein the communication interface receives a user control command which is input through the keyboard, and
wherein the controller generates image data according to the received control command.

10. A docking apparatus to mount an electronic apparatus thereon, comprising:
a first body where a display to display image data received from the electronic apparatus is disposed; and
a second body where a keyboard for receiving a control command to control the electronic apparatus is disposed,
wherein the electronic apparatus is mounted on an area of the second body between the keyboard and the display.

11. A controlling method of an electronic apparatus, comprising:
detecting whether the docking apparatus is connected;
when the electronic apparatus is mounted on the docking apparatus,
receiving a user control command using a touch screen which is disposed between a keyboard of the docking apparatus and a display; and
displaying image data on at least one of the display of the docking apparatus and the touch screen according to the input control command and whether the docking apparatus is mounted.

12. The method as claimed in claim 11, wherein the displaying comprises, when the docking apparatus is mounted and a control command that requires displaying on the touch screen is input, displaying image data on both the display of the docking apparatus and the touch screen,
when the docking apparatus is mounted and a control command that does not require displaying on the touch screen is input, displaying image data only on the display of the docking apparatus, and
when the docking apparatus is not mounted, displaying image data only on the touch screen.

13. The method as claimed in claim 12, wherein the displaying comprises, when the docking apparatus is mounted and a control command that requires displaying on the touch screen is input, displaying first image data on the touch screen, and displaying second image data on the display of the docking apparatus.

14. The method as claimed in claim 13, wherein the displaying comprises intercrossing and displaying image data which is displayed on the touch screen according to a predetermined control command.

15. The method as claimed in claim 14, wherein the predetermined control command is a predetermined touch pattern through the touch screen.

16. The method as claimed in claim 12, wherein the displaying comprises, when the docking apparatus is mounted and a control command that requires displaying on the touch screen is input, displaying first area of image data on the display of the docking apparatus, and displaying second area of the image data on the touch screen.

17. The method as claimed in claim 13, wherein the electronic apparatus operates under a plurality of operating systems, the first image data is image data according to an operation of a first operating system, and the second image data is image data according to an operation of a second operating system which is different from the first operating system.

18. The method as claimed in claim 12, wherein the displaying comprises, when the docking apparatus is mounted and a control command that does not require displaying on the touch screen is input, displaying first image data on the display of the docking apparatus while the touch screen operates only as a touch pad.

19. The method as claimed in claim 11, wherein the receiving a user control command comprises receiving a user control command which is input through a keyboard of the docking apparatus.

20. A computer readable recording medium including a program to execute a controlling method of an electronic apparatus, wherein the controlling method comprising:
detecting whether the docking apparatus is connected;
when the electronic apparatus is mounted on the docking apparatus, receiving a user control command using a touch screen which is disposed between a keyboard of the docking apparatus and a display; and
displaying image data on at least one of a display of the docking apparatus and the touch screen according to the input control command and whether the docking apparatus is mounted.
